(19) United States
(12) Patent Application Publication
(10) Pub. No.: US 2025/0115045 A1
(43) Pub. Date: Apr. 10, 2025

(54) LIQUID EJECTION HEAD

(71) Applicant: CANON KABUSHIKI KAISHA, Tokyo (JP)

(72) Inventor: MASATAKA NAGAI, Kanagawa (JP)

(21) Appl. No.: 18/908,661

(22) Filed: Oct. 7, 2024

(30) Foreign Application Priority Data
Oct. 10, 2023 (JP) 2023-174943
May 20, 2024 (JP) 2024-081643

(51) Int. Cl. B41J 2/14; B41J 2/17

(52) U.S. Cl. CPC B41J 2/14; B41J 2/1721

(57) ABSTRACT

A liquid ejection head includes an ejection port configured to eject liquid, a pressure generation element configured to generate pressure for ejecting the liquid from the ejection port, a pressure chamber on which the pressure by the pressure generation element acts, and a substrate where a supply port for supplying the liquid to the pressure chamber is formed, wherein a curved portion and a corner portion are provided at an end of a surface of the substrate on a pressure chamber side.

### BACKGROUND

### Field

The present disclosure relates to a liquid ejection head.

### Description of the Related Art

A liquid ejection head used in a liquid ejection apparatus, such as an inkjet printer, normally generates energy for ejection from an energy generation element provided in a pressure chamber and ejects liquid from an ejection port. To achieve higher-speed recording of such a liquid ejection apparatus, it is desirable to rapidly refill the liquid ejection head with liquid after the liquid is ejected from the ejection port. The liquid ejection head not sufficiently refilled with the liquid, for example, can eject the liquid with instability.

Japanese Patent No. 7171426 discusses a technique of removing a part of an insulating layer provided on a substrate by etching to expand the cross-sectional area of a liquid flow path, improving refill performance with liquid.

However, the method disclosed in Japanese Patent No. 7171426 has a limitation on expansion of the cross-sectional area of a liquid flow path due to the removal of an insulating layer alone provided on a substrate. In some cases, this makes it difficult to provide further improved refill performance. Further, there is an issue where the improved refill performance by the method disclosed in Japanese Patent No. 7171426 causes air bubbles to flow into the pressure chamber.

### SUMMARY

The present disclosure is directed to a technique providing further improved refill performance with a liquid ejection head that can decrease inflow of air bubbles into a pressure chamber.

According to some embodiments, a liquid ejection head includes an ejection port configured to eject liquid, a pressure generation element configured to generate pressure for ejecting the liquid from the ejection port, a pressure chamber on which the pressure by the pressure generation element acts, and a substrate where a supply port for supplying the liquid to the pressure chamber is formed, wherein a curved portion and a corner portion are provided at an end of a surface of the substrate on a pressure chamber side.

Further features of the present disclosure will become apparent from the following description of exemplary embodiments with reference to the attached drawings.

### BRIEF DESCRIPTION OF THE DRAWINGS

FIGS. 1A and 1B are schematic diagrams each illustrating a liquid ejection head according to a conventional example.

FIGS. 2A to 2D are schematic diagrams each illustrating a liquid ejection head according to a first exemplary embodiment.

FIG. 3 is a diagram illustrating a curved portion.

FIGS. 4A to 4C are schematic diagrams each illustrating a liquid ejection head according to a second exemplary embodiment.

FIGS. 5A to 5C are schematic diagrams each illustrating a liquid ejection head according to a third exemplary embodiment.

FIGS. 6A to 6D are schematic diagrams each illustrating a liquid ejection head according to a fourth exemplary embodiment.

FIGS. 7A to 7D are schematic diagrams each illustrating a liquid ejection head according to a modification of the fourth exemplary embodiment.

FIGS. 8A to 8C are schematic diagrams each illustrating a state of air bubbles according to the conventional example.

FIGS. 9A to 9C are schematic diagrams illustrating a state of air bubbles according to the fourth exemplary embodiment.

FIGS. 10A to 10D are schematic diagrams each illustrating a liquid ejection head according to a fifth exemplary embodiment.

FIGS. 11A to 11C are schematic diagrams each illustrating a liquid ejection head according to a sixth exemplary embodiment.

FIGS. 12A to 12C are schematic diagrams each illustrating a liquid ejection head according to a seventh exemplary embodiment.

FIGS. 13A to 13D are schematic diagrams each illustrating a liquid ejection head according to eighth to eleventh exemplary embodiments.

FIGS. 14A to 14D are schematic diagrams illustrating an effect of the exemplary embodiments.

FIGS. 15A to 15D are schematic diagrams illustrating an effect of the exemplary embodiments.

FIGS. 16A to 16D are schematic diagrams illustrating a manufacturing method.

FIGS. 17A to 17D are schematic diagrams illustrating a manufacturing method.

FIGS. 18A to 18D are schematic diagrams illustrating a manufacturing method.

FIGS. 19A to 19C are schematic diagrams illustrating other exemplary embodiments.

FIGS. 20A to 20C are schematic diagrams illustrating the other exemplary embodiments.

FIGS. 21A to 21D are schematic diagrams illustrating the other exemplary embodiments.

FIGS. 22A to 22D are schematic diagrams illustrating the other exemplary embodiments.

FIGS. 23A to 23D are schematic diagrams illustrating the other exemplary embodiments.

FIGS. 24A to 24D are schematic diagrams illustrating the other exemplary embodiments.

FIGS. 25A to 25C are schematic diagrams illustrating the other exemplary embodiments.

FIGS. 26A to 26C are schematic diagrams illustrating the other exemplary embodiments.

FIG. 27 is a schematic diagram illustrating the other exemplary embodiments.

### DESCRIPTION OF THE EMBODIMENTS

Various exemplary embodiments, features, and aspects of the present disclosure will now be described in detail with reference to the accompanying drawings.

In the drawings, the same members are denoted by the same reference numerals, and the redundant descriptions thereof are omitted.

A first exemplary embodiment will be described. A liquid ejection head using the present exemplary embodiment is mounted on an inkjet printer (not illustrated). While there are various types of inkjet printer, a printer generally includes a carriage (not illustrated) movable in scanning directions, and the carriage generally includes a liquid ejection head for ejecting liquid 16 onto a print medium. The liquid 16 is conveyed from an ink tank, and is replenished into a pressure chamber 10 via cover plate openings 14 through a common flow path 17 and introduction ports 8. In printing, the liquid 16 replenished into the pressure chamber 10 is ejected to a printing object through ejection ports 6 with energy from energy generation elements 4. Scanning with the carriage and ejection of the liquid are repeated to print a desired print pattern. A configuration enabling liquid circulation is further provided with collection ports 9. When circulated in a liquid flow path without performing ejection to prevent the viscosity from increasing, the liquid 16 is returned to the common flow path 17 through the collection ports 9.

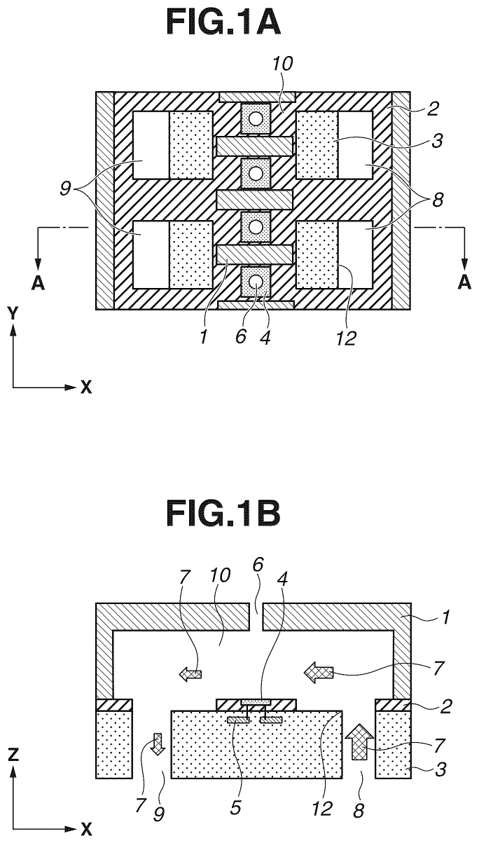

FIGS. 1A and 1B each illustrate a state of the liquid ejection head using a conventional technique. FIG. 1A is a plan view illustrating the vicinity of the surface of a substrate 3 in an enlarged manner. FIG. 1B is a cross-sectional view at an A-A position in FIG. 1A, and partly illustrates the liquid ejection head. The energy generation elements 4 are provided on the substrate 3, and flow path members 1 are provided above the energy generation elements 4 to define the liquid flow path and the pressure chamber 10. The substrate 3 further includes introduction ports 8 and the collection ports 9. A flowing direction and flow rate 7 of the liquid illustrated with arrows in the drawing indicates a flow from the introduction port 8 to the collection port 9. Part of an insulating layer 2 is removed by etching, which increases the cross-sectional area of the flow path. A corner portion 12 is provided on the surface of the substrate 3, the surface on which the energy generation elements 4 are provided.

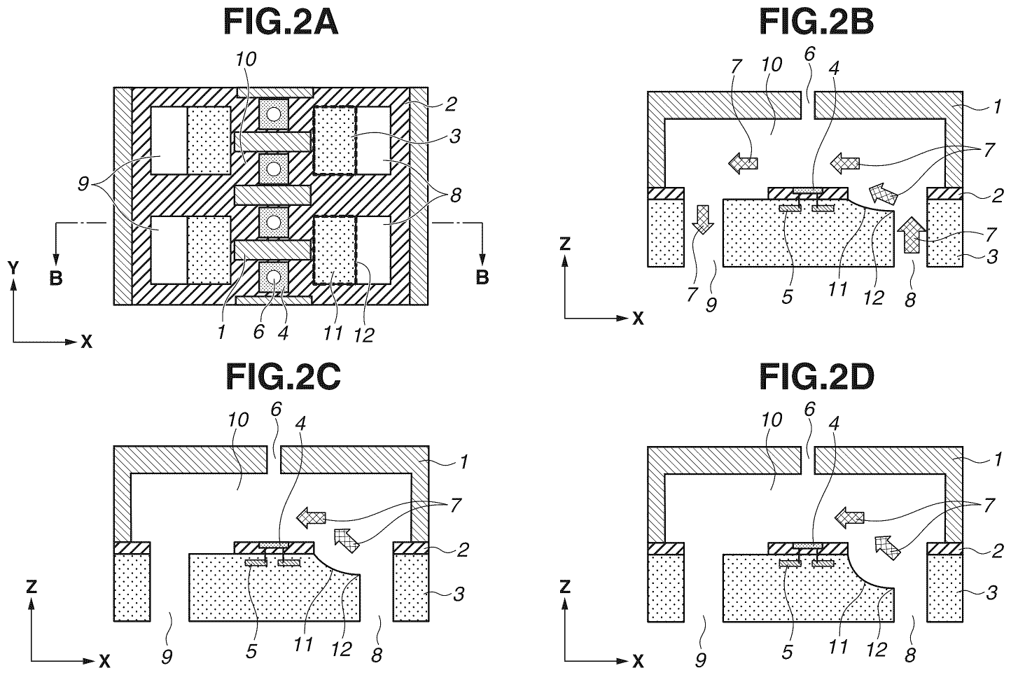

FIGS. 2A to 2D each illustrate the first exemplary embodiment of the present disclosure. FIG. 2A is a plan view illustrating the vicinity of the surface of the substrate 3 in an enlarged manner. FIG. 2B is a cross-sectional view at a B-B position in FIG. 2A, and partly illustrates a liquid ejection head. As illustrated in FIG. 2B, part of the substrate 3 upstream of the pressure chamber 10 is etched, the part of which has a curved portion 11 and a corner portion 12 absent in FIG. 1B. The curved portion 11 and the corner portion 12 are basically on the surface of the substrate 3 so that the curved portion 11 and the corner portion 12 come into contact with the liquid to produce an effect of the present exemplary embodiment. In FIGS. 2A to 2D, the curved portions 11 and the corner portions 12 are provided upstream of the respective pressure chambers 10 in a flowing direction of the liquid. FIGS. 2C and 2D are cross-sectional views each illustrating a modification of FIG. 2B. An increase in the amount of etching on the substrate 3 can increase the cross-sectional area of the flow path as compared with the case of FIG. 2B. Air bubbles are caught at each corner portion 12 in the liquid flow path, and are inhibited from being supplied into the pressure chambers 10 ahead. Each corner portion 12 is far from the corresponding pressure chamber 10 and the corresponding ejection port 6 as compared with the case of the conventional technique. This makes it possible to further prevent deterioration of printing quality caused by air bubbles.

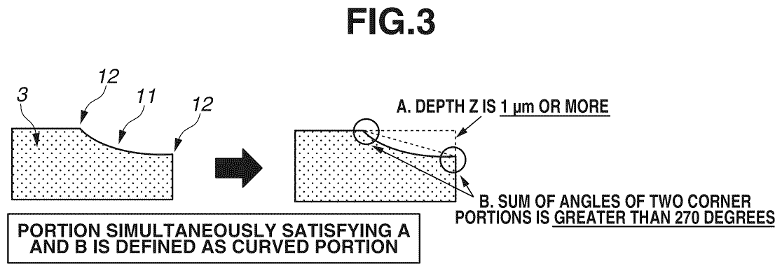

FIG. 3 is a diagram illustrating the definition of the curved portion 11 according to the present exemplary embodiment. The curved portion 11 is originally formed by, for example, etching at least a part of the portion corresponding to the liquid flow path of the substrate 3. Both corner portions 12 are each a structure portion having an angle, formed at a boundary between the above-described etched region and the unetched region. The curved portion 11 and the corner portions 12 come into direct contact with the liquid 16 to produce an effect of the present exemplary embodiment. The definition of the curved portion 11 will be described. As shown in FIG. 3, a virtual right triangle illustrated with a dashed line is provided along the corner portions 12 on the cross-sectional view of the curved portion 11. At this time, a first condition A is that a depth Z as the shortest side of the triangle is 1 micrometer (μm) or more. A second condition B is that the sum of angles of the two corner portions 12 at end parts of the curved portion 11 is greater than 270 degrees. A portion simultaneously satisfying the conditions A and B is defined as the curved portion 11.

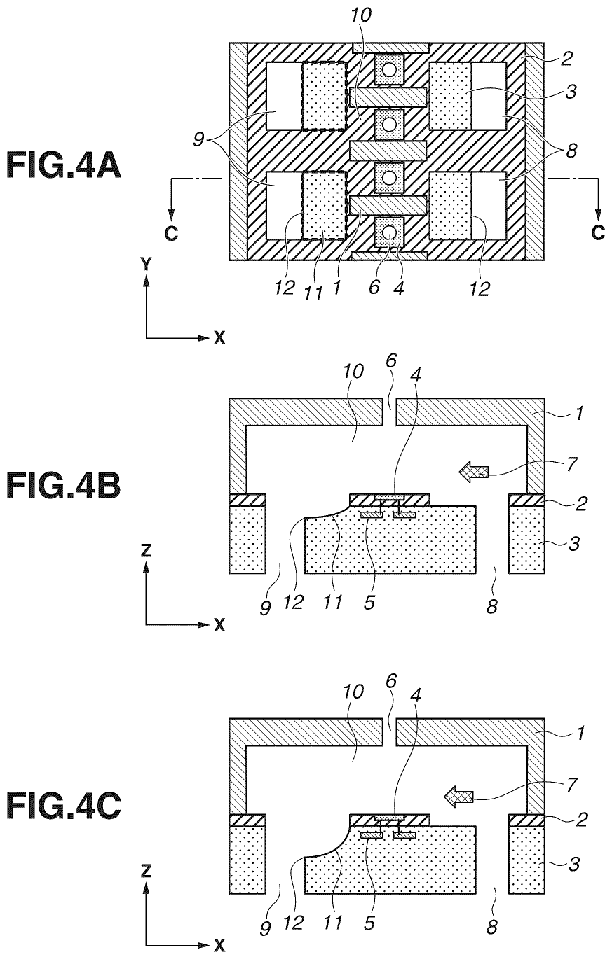

A second exemplary embodiment will be described. FIGS. 4A to 4C each illustrate the second exemplary embodiment of the present disclosure. FIG. 4A is a plan view illustrating the vicinity of the surface of the substrate 3 in an enlarged manner. FIG. 4B is a cross-sectional view at a C-C position in FIG. 4A and partly illustrates a liquid ejection head. As illustrated in FIG. 4B, part of the substrate 3 is etched, forming a curved portion 11 and a corner portion 12 downstream of the pressure chamber 10. FIG. 4C is a cross-sectional view illustrating a modification of FIG. 4B. An increase in the amount of etching on the substrate 3 can increase the cross-sectional area of the flow path as compared with the case of FIG. 4B. The increased cross-sectional area of the flow path in the downstream makes it possible to increase the amount of the liquid 16 discharged from the pressure chamber 10 to the collection port 9. Discharge of the liquid 16 from the pressure chamber 10 can increase the amount of the liquid 16 flowing from the introduction port 8 into the pressure chamber 10.

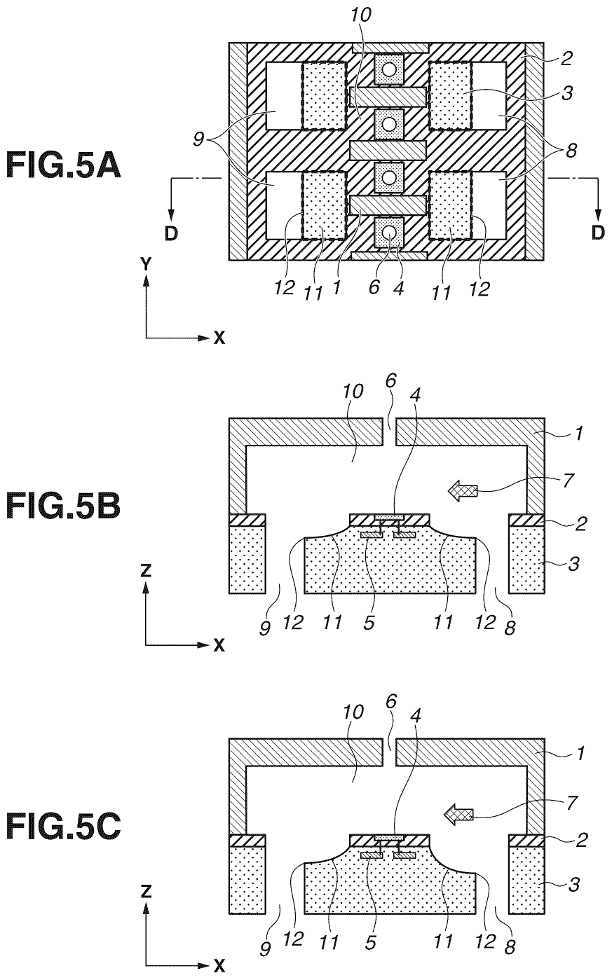

A third exemplary embodiment will be described. FIGS. 5A to 5C each illustrate the third exemplary embodiment. FIG. 5A is a plan view illustrating the vicinity of the surface of the substrate 3 in an enlarged manner. FIG. 5B is a cross-sectional view at a D-D position in FIG. 5A and partly illustrates a liquid ejection head. As illustrated in FIG. 5B, part of the substrate 3 is etched, forming curved portions 11 and corner portions 12 both upstream and downstream of the pressure chamber 10. FIG. 5C is a cross-sectional view illustrating a modification of FIG. 5B. An increase in the amount of etching on the substrate 3 can increase the cross-sectional area of the flow path as compared with the case of FIG. 5B. The increased cross-sectional area of the flow path on both the upstream and downstream sides makes it possible to efficiently increase the amounts of the liquid 16 supplied from the introduction port 8 into the pressure chamber 10, and of the liquid 16 discharged from the pressure chamber 10 to the collection port 9. Inflow and outflow of the liquid are increased to the same extent in the pressure chamber 10, which results in less stagnation caused by the difference between the two flow rates.

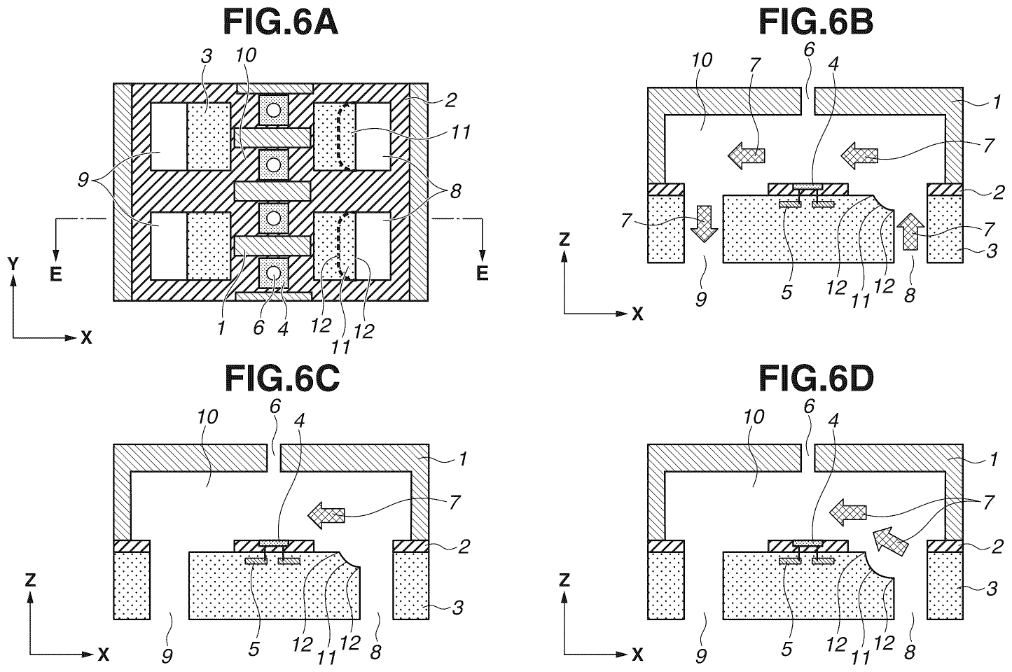

A fourth exemplary embodiment will be described. FIGS. 6A to 6D each illustrate the fourth exemplary embodiment. FIG. 6A is a plan view illustrating the vicinity of the surface of the substrate 3 in an enlarged manner. FIG. 6B is a cross-sectional view at an E-E position in FIG. 6A and partly illustrates a liquid ejection head. As illustrated in FIG. 6B, part of the substrate 3 upstream of the pressure chamber 10 is etched, forming a curved portion 11 and two corner portions 12.

Air bubbles 15 are caught at the two corner portions 12 in the liquid flow path, and are inhibited from being supplied into the pressure chamber 10 ahead. The number of corner portions 12 is increased in the liquid flow path from the introduction port 8 to the pressure chamber 10 as compared with the first exemplary embodiment, which facilitates catching more of the air bubbles 15. This makes it possible to further prevent deterioration of printing quality caused by the air bubbles 15. FIG. 6C and FIG. 6D are cross-sectional views illustrating modifications of FIG. 6B. An increase in the amount of etching on the substrate 3 can increase the cross-sectional area of the flow path as compared with the case of FIG. 6B. This can be effective for both issues with the flow rate and the air bubbles 15. Further, the corner portions 12 are far from the pressure chamber 10 and the ejection ports 6, which makes it possible to further prevent deterioration of printing quality caused by the air bubbles 15. The exemplary embodiments are selectable depending on the content of the issues to be solved.

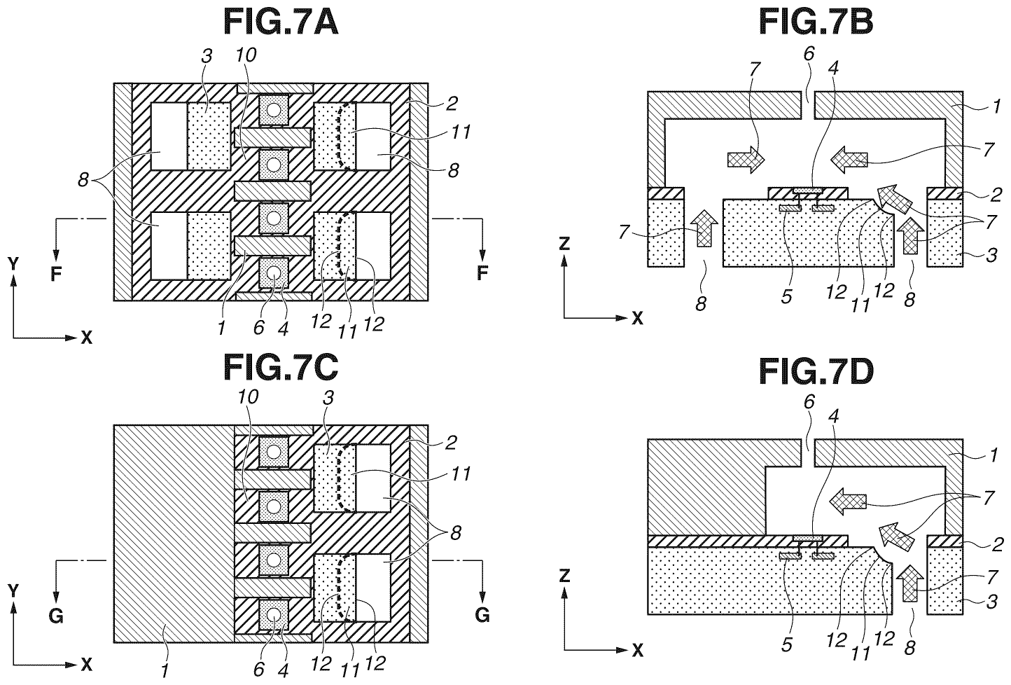

FIGS. 7A to 7D are diagrams each illustrating a configuration according to the fourth exemplary embodiment of the present disclosure. FIG. 7A is a plan view illustrating a configuration in which the liquid is supplied into one pressure chamber from two introduction ports, and FIG. 7B is a cross-sectional view at an F-F position in FIG. 7A. While the shape is similar to that according to the fourth exemplary embodiment, an introduction port 8 is at the position of the collection port 9. In this case, the configuration has no liquid circulation function, but the liquid 16 is supplied from the two introduction ports 8 on the right and left, improving refill performance of the pressure chamber 10. FIG. 7C is a plan view illustrating a configuration where the liquid is supplied into one pressure chamber from one introduction port without a collection port. FIG. 7D is a cross-sectional view at a G-G position in FIG. 7C.

This configuration includes no collection port 9, and the liquid flow path and the introduction port 8 are on the right of the pressure chamber 10 alone. While improved refill performance with such a configuration is also in growing demand, application of the present exemplary embodiment can improve refill performance.

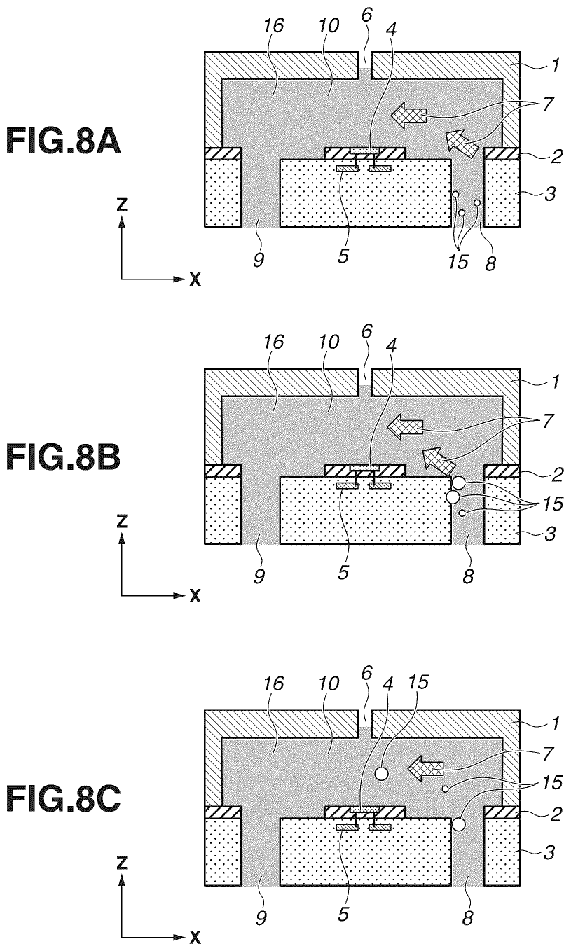

FIGS. 8A to 8C are diagrams each illustrating movement and a growing state of air bubbles in the liquid in a conventional configuration. FIG. 8A illustrates a state where three air bubbles 15 are inside the introduction port 8, as an example. As illustrated in FIG. 8B, it is known that the air bubbles 15 in the liquid 16 grow in a process where the liquid 16 moves along the wall surface in the liquid flow path. The grown air bubbles 15 move along the wall surface of the introduction port 8, and other air bubbles 15 in the liquid 16 further move toward the pressure chamber 10. At this time, the liquid flows not only in a vertical direction and a lateral direction but also in an oblique direction as in the drawing. As illustrated in FIG. 8C, in the conventional configuration, the wall surface or the corner portion 12 acts as a resisting object against the air bubbles 15, some of the air bubbles 15 are caught particularly on the corner portion where the vector of the flow is changed, and the caught air bubbles 15 does not move thereafter. In other words, some of the air bubbles 15 are stuck short of the pressure chamber 10. However, many other air bubbles 15 flow into the pressure chamber 10 in the flow of the liquid 16.

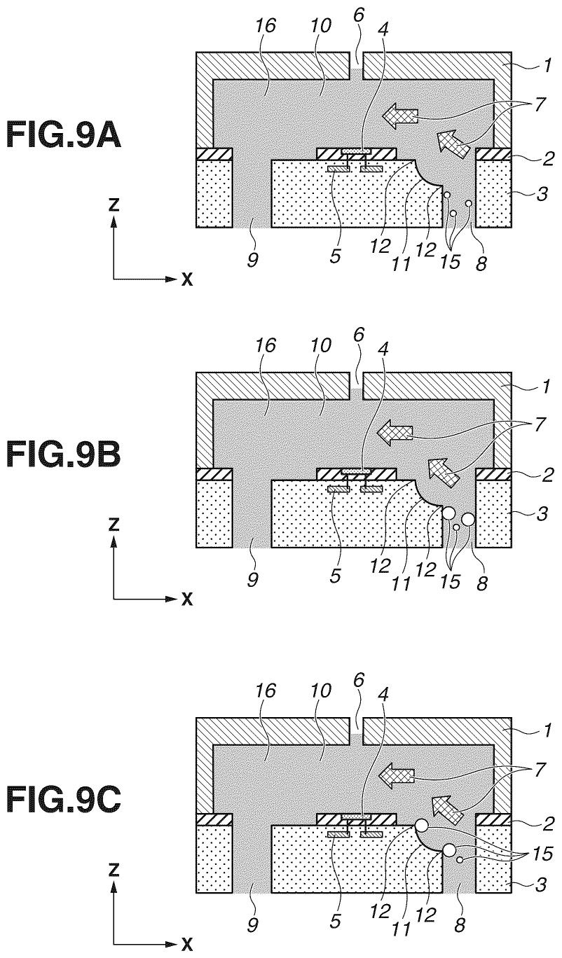

FIGS. 9A to 9C are diagrams each illustrating a configuration including a plurality of corner portions 12 according to the fourth exemplary embodiment, the configuration improving trapping performance for the air bubbles 15. FIG. 9A illustrates a state where three air bubbles 15 are inside the introduction port 8, as an example. As illustrated in FIG. 9B, the air bubbles 15 in the liquid 16 grow in a process where the liquid 16 moves along the wall surface in the liquid flow path. The grown air bubbles 15 further move along the wall surface of the introduction port 8, and other air bubbles 15 in the liquid 16 further move toward the pressure chamber 10. At this time, the liquid flows not only in the vertical direction and the lateral direction but also in the oblique direction as illustrated in the drawing. As illustrated in FIG. 9C, in the fourth exemplary embodiment of the present disclosure, the wall surface or the corner portions 12 act as a resisting object against the air bubbles 15, and more air bubbles 15 are easily caught particularly on the corner portions 12 where the vector of the flow is changed. The air bubbles 15 caught once will not move thereafter. In the fourth exemplary embodiment, the plurality of corner portions 12 lead to increase in the number of resisting objects catching the air bubbles 15, causing more air bubbles 15 to be stuck short of the pressure chamber 10 than those in the conventional configuration. Consequently, the application of the present exemplary embodiment leads to improvement in the refill performance and prevention of inflow of the air bubbles 15 into the pressure chamber 10.

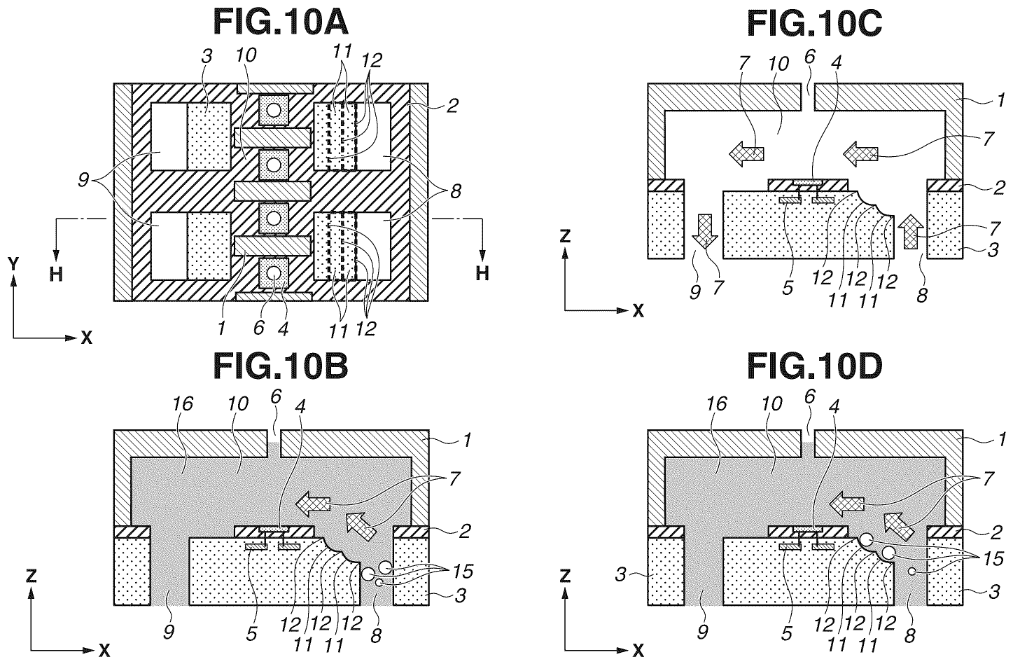

A fifth exemplary embodiment will be described. FIGS. 10A to 10D each illustrate the fifth exemplary embodiment. FIG. 10A is a plan view illustrating the vicinity of the surface of the substrate 3 in an enlarged manner. FIG. 10B is a cross-sectional view at an H-H position in FIG. 10A and partly illustrates a liquid ejection head. As illustrated in FIG. 10B, part of the substrate 3 upstream of the pressure chamber 10 is etched, forming curved portions 11 and three corner portions 12. FIGS. 10C and 10D are diagrams each illustrating trapping performance for the air bubbles 15 improved by increasing the number of corner portions 12 up to three. FIG. 10C illustrates a state where three air bubbles 15 are inside the introduction port 8, as an example.

The air bubbles 15 in the liquid 16 grow in a process where the liquid 16 moves along the wall surface in the liquid flow path. The grown air bubbles 15 move along the wall surface of the introduction port 8, and other air bubbles 15 in the liquid 16 further move toward the pressure chamber 10. At this time, the liquid flows not only in the vertical direction and the lateral direction but also in the oblique direction as illustrated in the drawing.

As illustrated in FIG. 10D, in the fifth exemplary embodiment of the present disclosure, the wall surface or the corner portions 12 act as resisting objects against the air bubbles 15, and more air bubbles 15 are easily caught particularly on the corner portions 12 at where the vector of the flow is changed. Since the number of corner portions 12 is increased as compared with the fourth exemplary embodiment, the air bubbles 15 are inhibited from being supplied into the pressure chamber 10 ahead. The air bubbles 15 caught once will not move thereafter. The plurality of corner portions 12 leads to increase in the number of resisting objects catching the air bubbles 15, causing more air bubbles 15 to be stuck short of the pressure chamber 10 than those in the conventional configuration. Consequently, the application of the present exemplary embodiment brings about improvement in the refill performance and prevents inflow into the pressure chamber 10. In other words, this can further prevent deterioration of printing quality caused by the air bubbles 15.

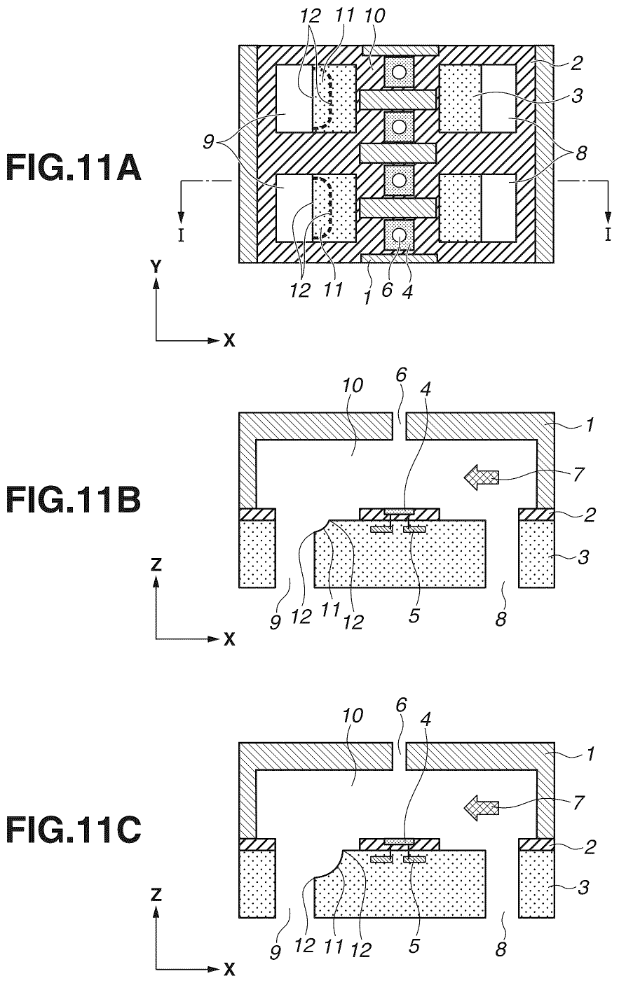

A sixth exemplary embodiment will now be described. FIGS. 11A to 11C each illustrate the sixth exemplary embodiment. FIG. 11A is a plan view illustrating the vicinity of the surface of the substrate 3 in an enlarged manner. FIG. 11B is a cross-sectional view at an I-I position in FIG. 11A and partly illustrates a liquid ejection head. As illustrated in FIG. 11B, part of the substrate 3 downstream of the pressure chamber 10 is etched, forming a curved portion 11 and two corner portions 12. FIG. 11C is a cross-sectional view illustrating a modification of FIG. 11B. An increase in the amount of etching on the substrate 3 can increase the cross-sectional area of the flow path as compared with the case of FIG. 11B. The increased the cross-sectional area of the flow path in the downstream makes it possible to increase the amount of the liquid 16 discharged from the pressure chamber 10 to the collection port 9. Discharge of the liquid 16 from the pressure camber 16 can increase the amount of the liquid 16 flowing from the introduction port 8 into the pressure chamber.

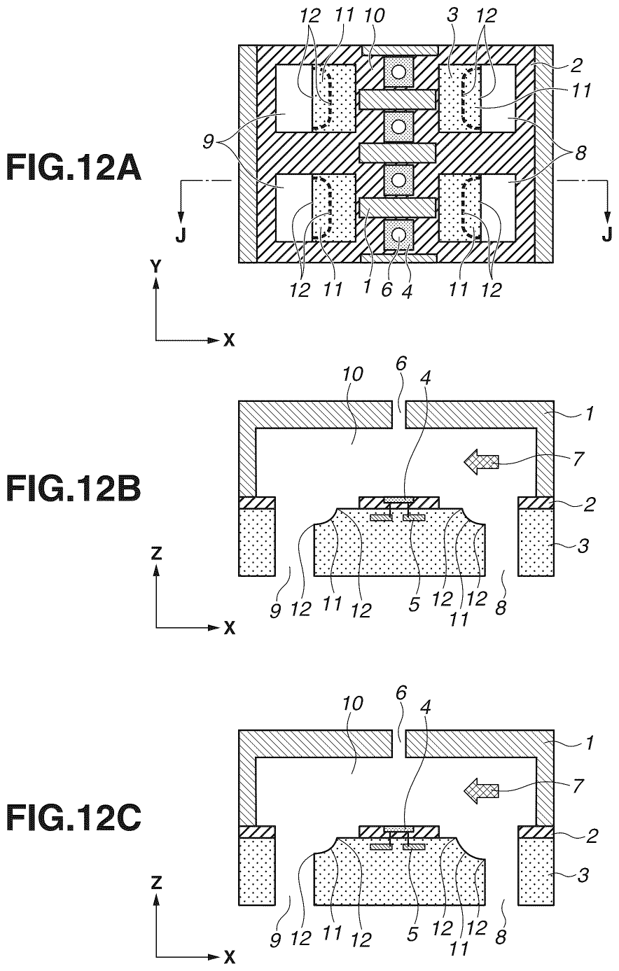

A seventh exemplary embodiment will be described. FIGS. 12A to 12C each illustrate the seventh exemplary embodiment. FIG. 12A is a plan view illustrating the vicinity of the surface of the substrate 3 in an enlarged manner. FIG. 12B is a cross-sectional view at a J-J position in FIG. 12A and partly illustrates a liquid ejection head. As illustrated in FIG. 12B, part of the substrate 3 is etched, forming a curved portion 11 and two corner portions 12 each upstream and downstream of the pressure chamber 10. FIG. 12C is a cross-sectional view illustrating a modification of FIG. 12B. An increase in the amount of etching on the substrate 3 can increase the cross-sectional area of the flow path as compared with the case of FIG. 12B. The increased cross-sectional area of the flow path on both the upstream and downstream sides makes it possible to efficiently increase the amount of the liquid 16 discharged from the pressure chamber 10 to the collection port 9. Inflow and outflow of the liquid into and out of the pressure chamber 10 are increased to the same extent, which results in less stagnation caused by the difference between the two flow rates.

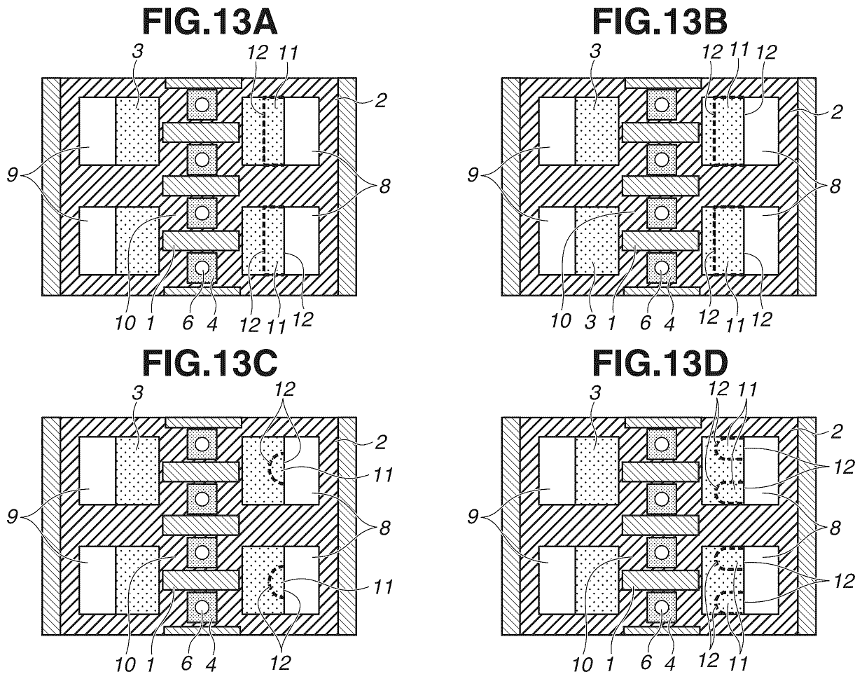

Eighth to eleventh exemplary embodiments will be described. FIGS. 13A to 13D are plan views illustrating exemplary embodiments different in configuration in a horizontal direction (an XY direction). FIG. 13A is a diagram illustrating the eighth exemplary embodiment, FIG. 13B is a diagram illustrating the ninth exemplary embodiment, FIG. 13C is a diagram illustrating the tenth exemplary embodiment, and FIG. 13D is a diagram illustrating the eleventh exemplary embodiment. While the cross-sectional views are omitted, each of the cross-sectional shapes according to the eighth to eleventh exemplary embodiments is extremely similar to that illustrated in FIG. 6B due to the plurality of corner portions 12 provided on the upstream side. An example of the positions of the corner portions 12 (the shape of corner portions 12) in the horizontal direction (the XY direction) is illustrated in FIG. 6A, and the shape of corner portions 12 are each formed in an arc shape in the horizontal direction (the XY direction).

In contrast, the curved portions 11 according to the eighth exemplary embodiment illustrated in FIG. 13A each have a linear shape, and occupy substantially a half of the flat regions on the substrate 3. When the boundary has a linear shape, the present exemplary embodiment can be implemented with high reproducibility without being affected by etching and resolution of the pattern of an etching-resistant resist used in etching. The curved portions 11 according to the ninth exemplary embodiment illustrated in FIG. 13B have a linear shape, and occupy substantially a three-quarter of the flat region on the substrate 3. The regions of the curved portions 11 are each expanded, which makes it possible to increase not only the amount of etching in a perpendicular direction (a Z direction) but also the amount of etching in the horizontal direction (the XY direction).

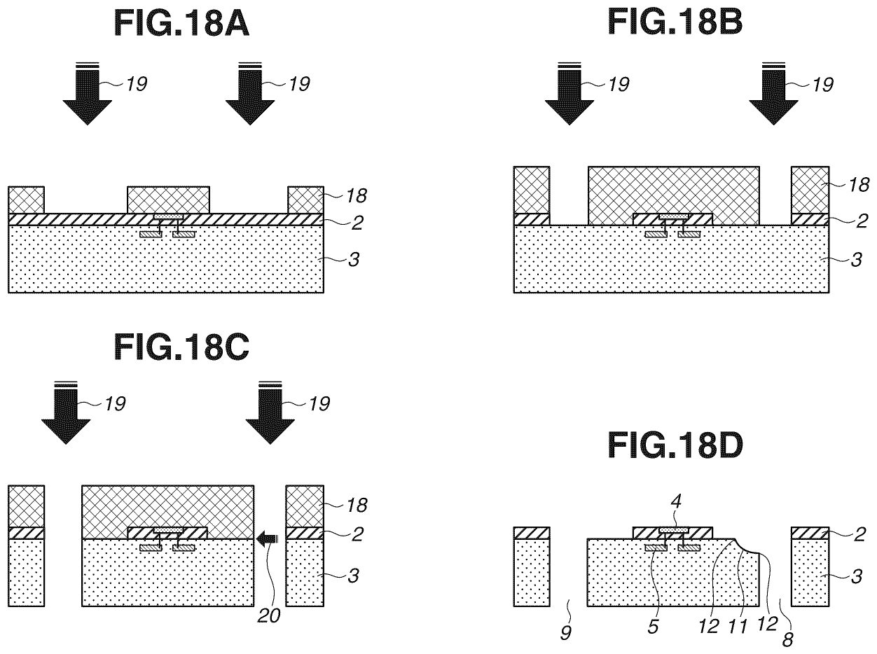

A difference from the first exemplary embodiment is more corner portions 12. The curved portions 11 according to the tenth exemplary embodiment illustrated in FIG. 13C each have an arc shape, and one curved portion 11 is provided for one introduction port 8. This configuration can be easily formed by using a manufacturing method illustrated in FIGS. 18A to 18D without adding a step. The curved portions 11 according to the eleventh exemplary embodiment illustrated in FIG. 13D each have an arc shape, and two curved portions 11 are provided for one introduction port 8. The curved portions 11 each provided closer to the corresponding ejection port 6 easily affect liquid flowing from the introduction port 8 into the pressure chamber 10, which produces the effect of the present exemplary embodiment effectively.

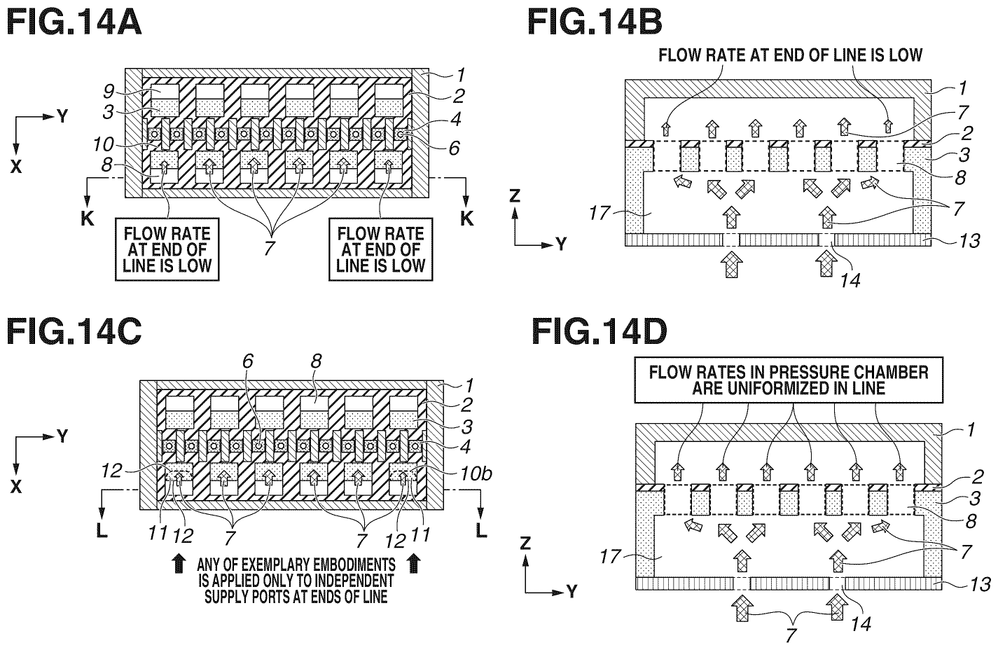

FIGS. 14A to 14D are diagrams illustrating a further effect produced by applying any one of the exemplary embodiments of the present disclosure to end parts alone of one line. FIG. 14A is a plan view illustrating an example of an issue, and FIG. 14B is a cross-sectional view at a K-K position in FIG. 14A. As in FIG. 14B, the liquid 16 passes through the cover plate openings 14, flows in the flowing directions illustrated as the flow rates 7 in the region surrounded by the common flow path 17 and a cover plate 13, and further flows toward the pressure chamber 10 through the introduction ports 8. In a case where the introduction ports 8 have the same shape as each other, the liquid 16 suffers a loss of the flow rate at the same degree when the liquid 16 passes through the introduction ports 8, further reducing the flow rate of the liquid reaching the pressure chamber 10.

As a result, there occurs the issue that the flow rates at the end parts of the line are lower than those at the other parts of the same line as illustrated in FIG. 14A. Under such situations, continuous printing causes insufficient refilling at the end parts of the line, which can affect quality of printed products. Thus, as illustrated in FIGS. 14C and 14D, the curved portions and the corner portions can be provided only at the end parts of the line. FIG. 14C is a plan view illustrating a state where any of the exemplary embodiments of the present disclosure is applied to the end parts of the line, and FIG. 14D is a cross-sectional view at an L-L position in FIG. 14C. In the introduction ports 8 to which the present exemplary embodiment is applied, the loss of the flow rate can be reduced when the liquid 16 passes through the introduction ports 8 compared with the other introduction ports 8. Thus, the flow rates in the pressure chamber 10 can be uniformized between at the end parts and the other parts of the line.

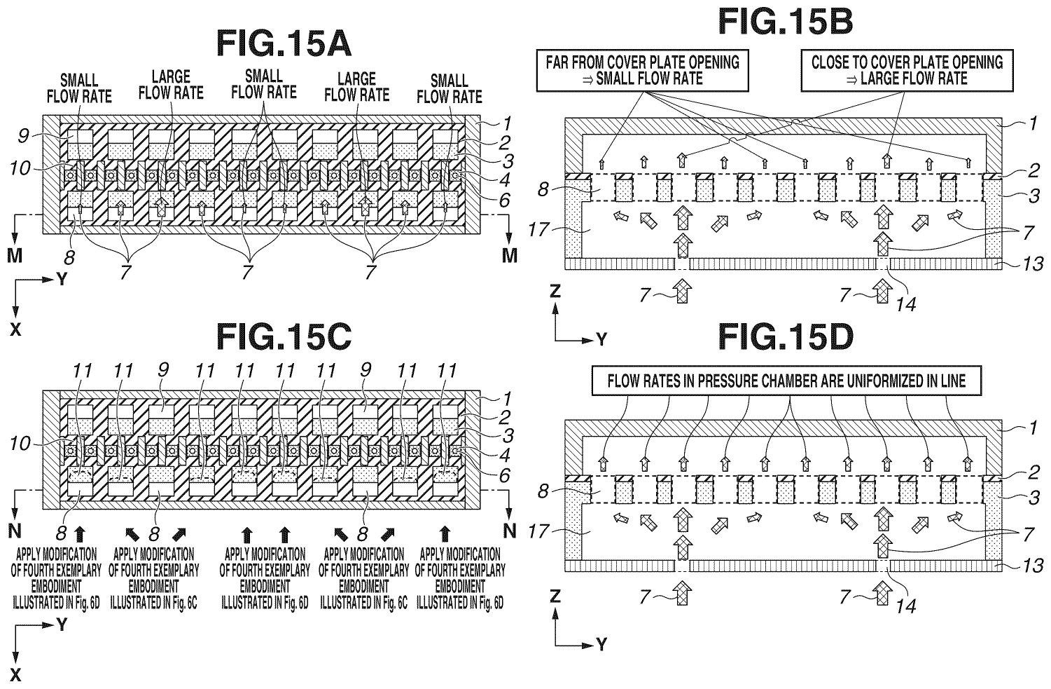

FIGS. 15A to 15D are diagrams illustrating a further effect produced by applying a plurality of different exemplary embodiments to parts in one line. FIG. 15A is a plan view illustrating an example of an issue, and FIG. 15B is a cross-sectional view at an M-M position in FIG. 15B. As in FIG. 15B, the liquid 16 passes through the cover plate openings 14, flows in the flowing directions illustrated as the flow rates 7 in the region surrounded by the common flow path 17 and the cover plate 13, and further flows toward the pressure chamber 10 through the introduction ports 8. The cover plate openings 14 are limited in the position and size, and cannot be freely disposed. Thus, the distance to one introduction port 8 from the corresponding cover plate opening 14 is different from the distances to the other introduction ports in a stepwise manner depending on the position of the introduction port 8. In the common flow path 17, the farther away the position of the introduction port 8 is from the corresponding cover plate opening 14, the flow rate may be gradually lower as the introduction port 8 is farther. When the liquid 16 passes through the introduction ports 8 having the same shape as each other, substantially the same flow rate is lost at each of the introduction ports 8. This further decreases the flow rate of the liquid flowing into the pressure chamber 10.

Thus, a farther position from the corresponding cover plate opening 14 has the issue that the farther away the position of the introduction port 8 is from the corresponding cover plate openings 14, the lower the flow rate can be as illustrated in FIG. 15A. Under such situations, continuous printing causes insufficient refilling at positions far from the corresponding cover plate opening 14, which can affect the quality of printed products extensively. Thus, as illustrated in FIGS. 15C and 15D, different exemplary embodiments can be applied to the same line in a stepwise manner.

FIG. 15C is a plan view illustrating a state where a plurality of different exemplary embodiments is applied to parts of the line, and FIG. 15D is a cross-sectional view at an N-N position in FIG. 15C. In an example illustrated in FIG. 15C, none of the exemplary embodiments is applied to the positions close to the corresponding cover plate opening 14, the modification of the fourth exemplary embodiment illustrated in FIG. 6C is applied to positions relatively close to the corresponding cover plate opening 14, and the modification of the fourth exemplary embodiment illustrated in FIG. 6D is applied to positions far from the corresponding cover plate opening 14.

With the different exemplary embodiments appropriately applied to the positions of the introduction ports 8 depending on the position in the Y direction, the loss of the flow rate when the liquid 16 passes through the introduction ports 8 can be reduced compared with the case where the different exemplary embodiments are not applied. This makes it possible to uniformize the flow rates in the same line in the pressure chamber 10 as illustrated in FIG. 15D.

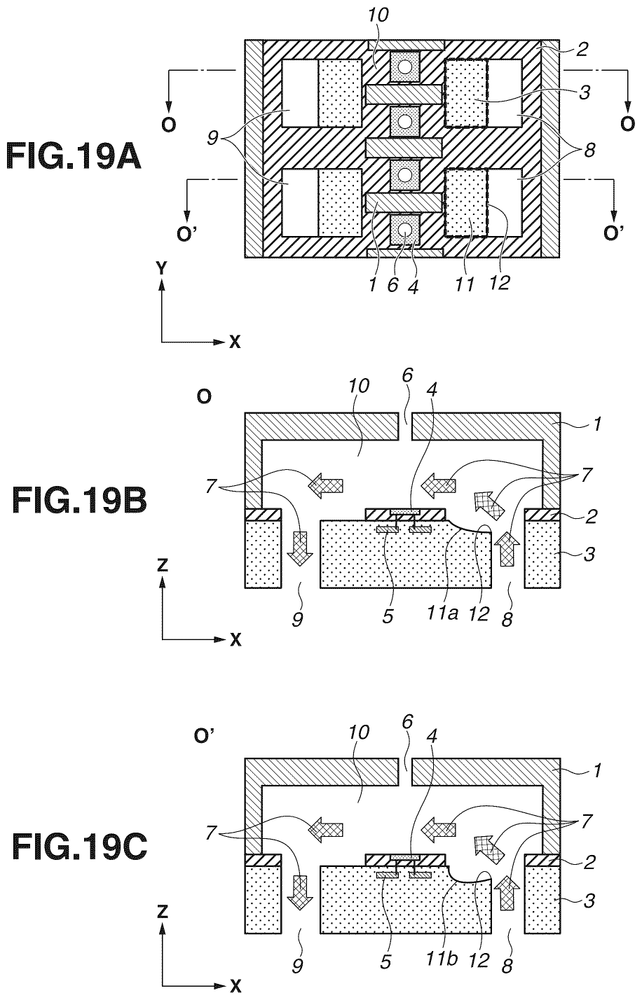

Other exemplary embodiments will be described. FIGS. 19A to 19C, 20A to 20C, 21A to 21D, 22A to 22D, 23A to 23D, 24A to 24D, 25A to 25C, 26A to 26C, and 27 are schematic diagrams illustrating other exemplary embodiments of the present disclosure. FIG. 19A is a plan view, FIG. 19B is a cross-sectional view at an O-O position in FIG. 19A, and FIG. 19C is a cross-sectional view at an O′-O′ position in FIG. 19A. FIGS. 19A to 19C each illustrates a state where, a plurality of provided curved portions, which are a first curved portion 11a illustrated in FIG. 19B and a second curved portion 11b illustrated in FIG. 19C, are identical in the position of the corner portion when viewed in the cross sections, but are different in the shape of the curved surface. Thus, in the region from the plurality of introduction ports 8 to the pressure chamber 10, which form one head, the deepest positions of the curved portions 11 in the direction perpendicular to the substrate 3 can be different depending on the position in the substrate 3, as in the curved portion 11a and the curved portion 11b illustrated in FIG. 19B and FIG. 19C, respectively.

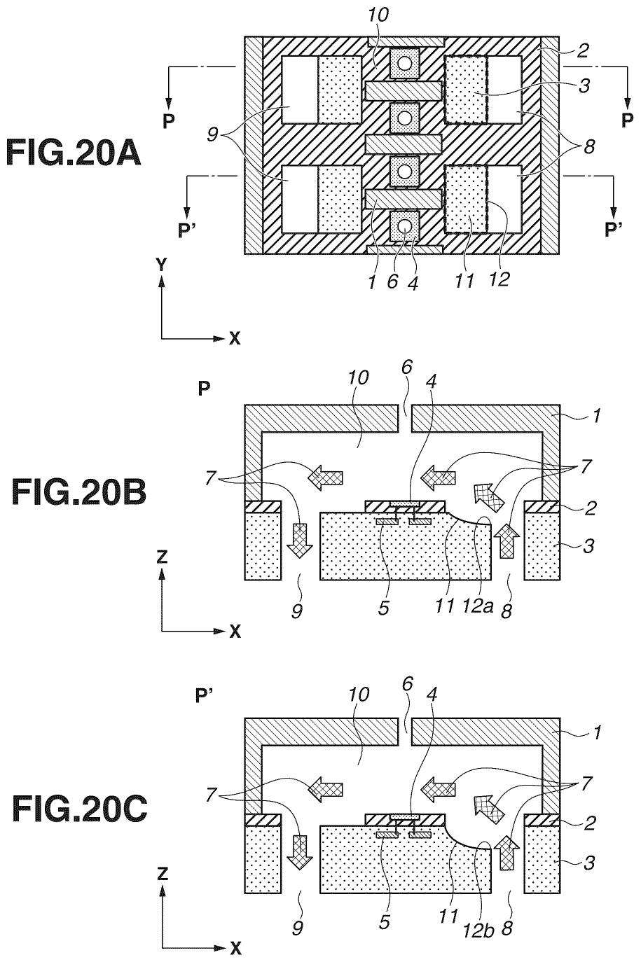

FIG. 20A is a plan view, FIG. 20B is a cross-sectional view at a P-P position in FIG. 20A, and FIG. 20C is a cross-sectional view at a P′-P′ position in FIG. 20A. A first corner portion 12a illustrated in FIG. 20B and a second corner portion 12b illustrated in FIG. 20C are provided at positions different from each other in the direction perpendicular to the substrate 3 when viewed in the cross-sections. In the region from the plurality of introduction ports 8 to the pressure chamber 10, which form one head, the positions of the corner portions 12 in the direction perpendicular to the substrate 3 are different depending on the position in the substrate 3, as in the corner portion 12a and the corner portion 12b shown in FIG. 20B and FIG. 20C, respectively. Such a configuration is also an example of a configuration in exemplary embodiments of the present disclosure.

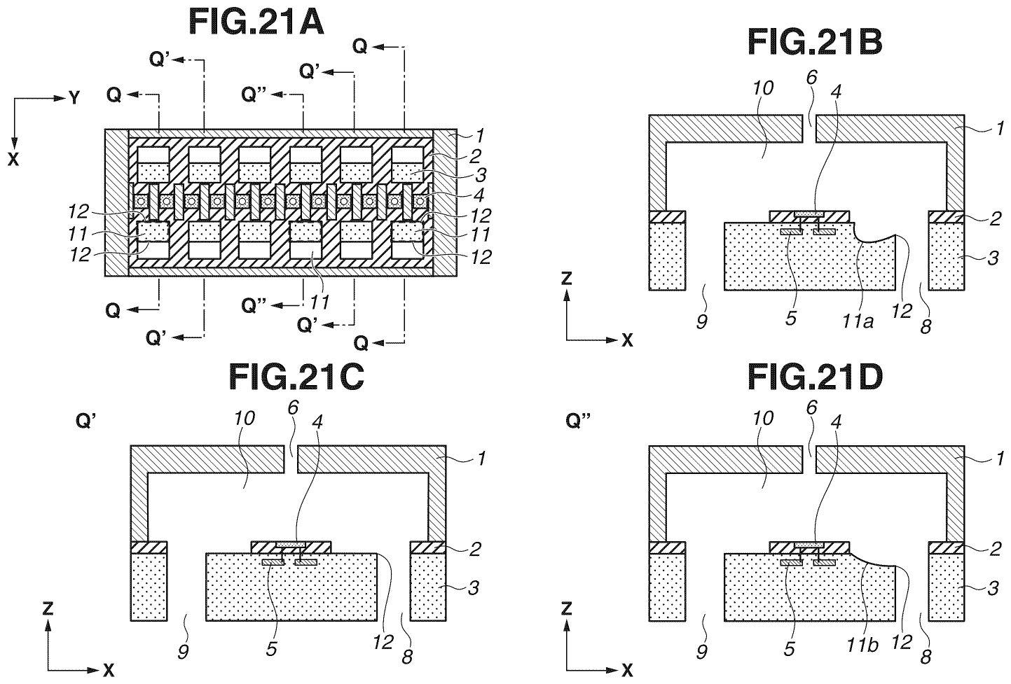

FIG. 21A is a plan view, FIG. 21B is a cross-sectional view at a Q-Q position in FIG. 21A, and FIG. 21C is a cross-sectional view at a Q′-Q′ position in FIG. 21A. FIG. 21D is a cross-sectional view at a Q″-Q″ position in FIG. 21A. In FIG. 21A, a plurality of curved portions 11 is provided along a plurality of pressure chambers 10 to form a curved portion line. Among plurality of provided curved portions 11, a first curved portion 11a illustrated in FIG. 21B and a second curved portion 11b illustrated in FIG. 21D are identical in the position of the corner portion 12 when viewed at the cross sections, but are different in the shape of the curved surface. Thus, in the arrangement of the plurality of curved portions, the deepest positions of the curved portions 11 in the direction perpendicular to the substrate 3 are different between the curved portions located at the ends and other than the ends of the line. In the region from the plurality of introduction ports 8 to the pressure chamber 10, which form one head, the deepest positions of the curved portions 11 in the direction perpendicular to the substrate 3 can be different between the curved portions located at the ends and other than the ends of the line in the substrate 3 as in the curved portion 11a and the curved portion 11b illustrated in FIG. 21B and FIG. 21D, respectively. As illustrated in FIG. 21C, no curved portions 11 can be provided in the region from the introduction ports 8 to the pressure chamber 10 at a Q′-Q′ position between the line Q-Q and the line Q″-Q″ in FIG. 21A. Such a configuration is also an example of a configuration in exemplary embodiments of the present disclosure.

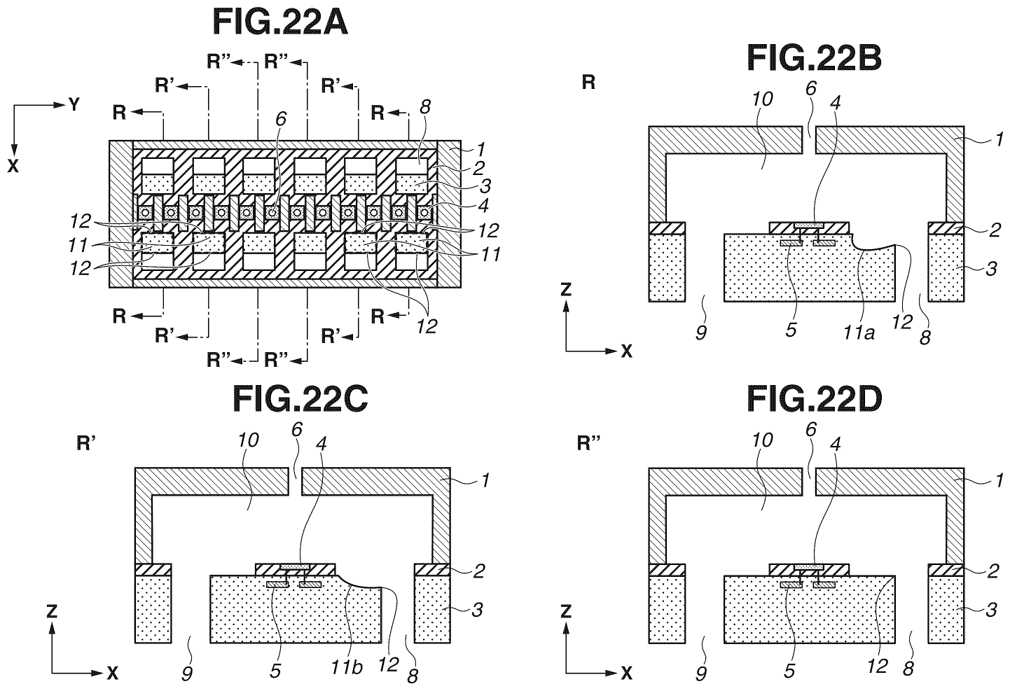

FIG. 22A is a plan view, FIG. 22B is a cross-sectional view at an R-R position in FIG. 22A, FIG. 22C is a cross-sectional view at an R′-R′ position in FIG. 22A, FIG. 22D is a cross-section view at an R″-R″ position in FIG. 22A. Comparing FIGS. 22A to 22D and FIGS. 21A to 21D, in the regions from the plurality of introduction ports 8 to the pressure chambers 10, the positions where no curved portions are provided are different, and no curved portions are provided at R″-R″ positions in the middle of FIG. 22A. Such a configuration is also an example of a configuration in exemplary embodiments of the present disclosure.

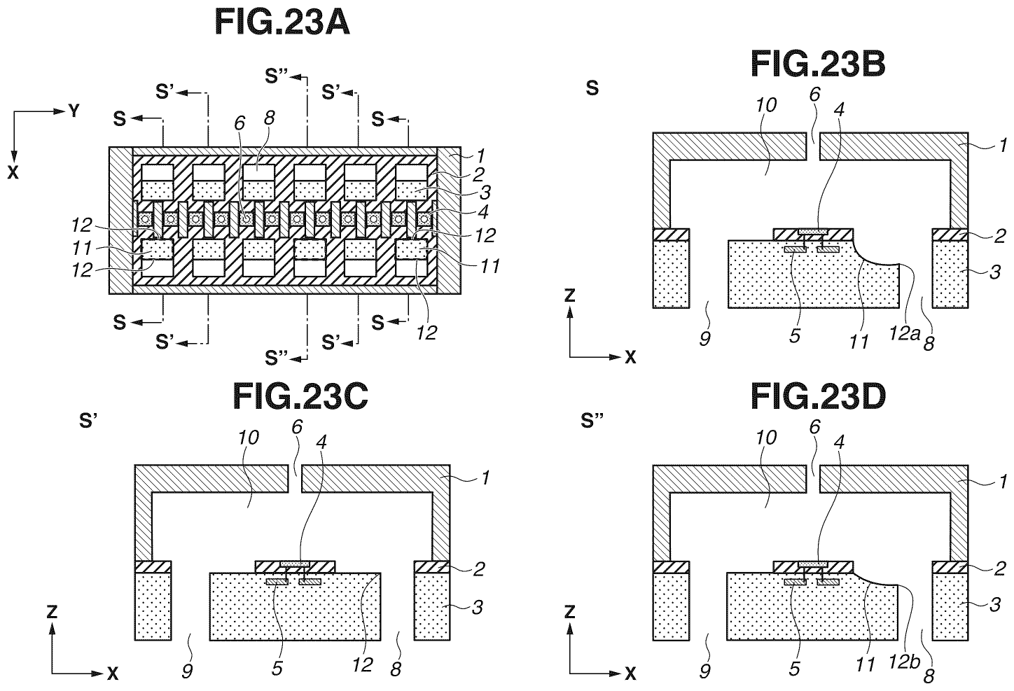

FIG. 23A is a plan view, FIG. 23B is a cross-sectional view at a S-S position in FIG. 23A, and FIG. 23C is a cross-sectional view at an S′-S′ position in FIG. 23A. FIG. 23D is a cross-sectional view at a S″-S″ position in FIG. 23A. Among plurality of corner portions 12, a first corner portion 12a illustrated in FIG. 23B and a second corner portion 12b illustrated in FIG. 23D are provided at positions different from each other when viewed in the cross-sections. As described above, in the exemplary embodiments, the positions of the corner portions 12 are different in the regions from the plurality of introduction ports 8 to the pressure chambers 10, which forms one head. Further, as illustrated in FIG. 23C, no curved portions 11 can be provided at a S′-S′ position between the line S-S and the line S″-S″ from the introduction ports 8 to the pressure chamber in FIG. 23A. Such a configuration is also an example of a configuration in exemplary embodiments of the present disclosure.

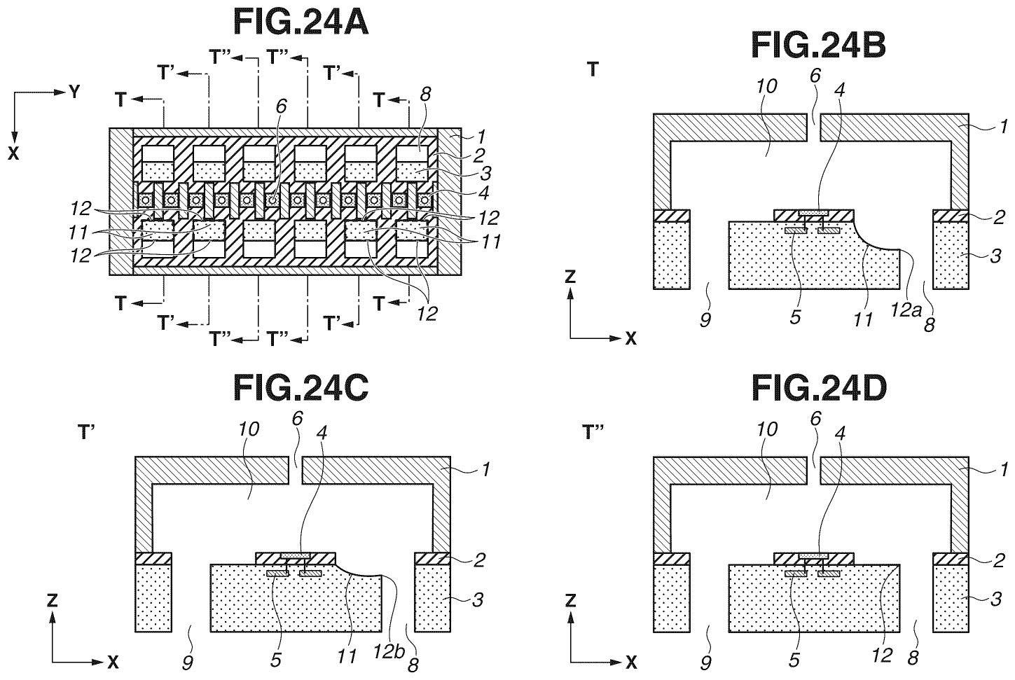

FIG. 24A is a plan view, FIG. 24B is a cross-sectional view at a T-T position in FIG. 24A, and FIG. 24C is a cross-sectional view at a T′-T′ position in FIG. 24A. FIG. 24D is a cross-sectional view at a T″-T″ position in FIG. 24A. Comparing FIGS. 24A to 24D and FIGS. 23A to 23D, in the regions from the plurality of introduction ports 8 to the pressure chambers 10, the positions where no curved portions are provided are different, and no curved portions are provided at T″-T″ positions in the middle of FIG. 24A. Such a configuration is also an example of a configuration in exemplary embodiments of the present disclosure.

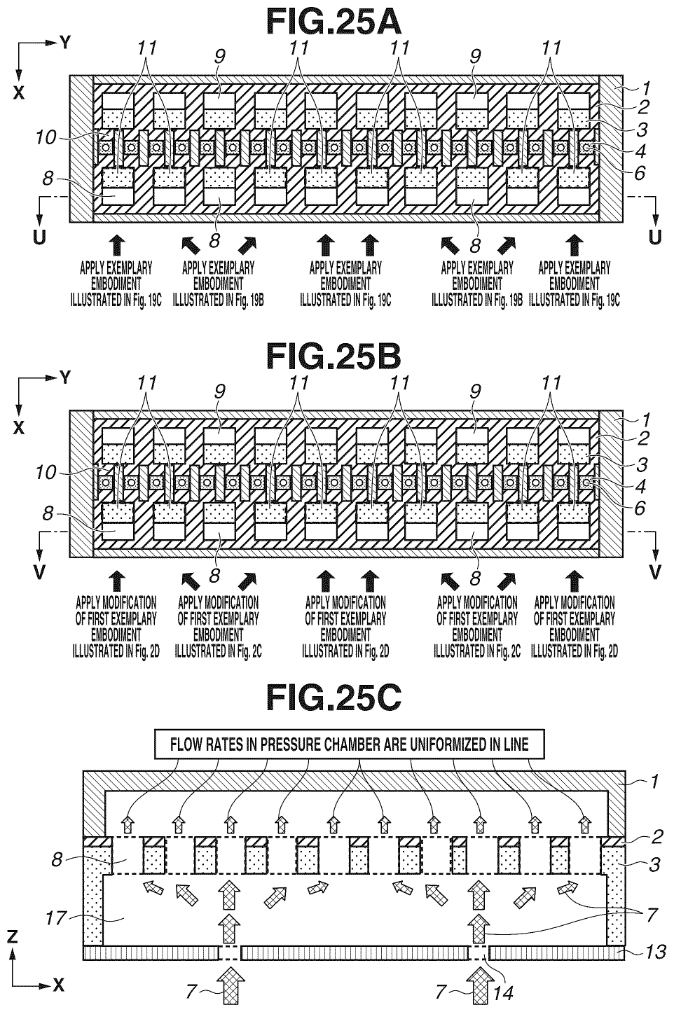

FIGS. 25A to 25C each illustrate a state where a plurality of combinations (ten combinations in the drawings) of one supply port 8 and one recovery port 9 for two pressure chambers 10 is provided. As illustrated in FIG. 25C, a cover plate is formed at a surface of the substrate opposite from the pressure chamber, and a plurality of (two in the drawings) openings 14 are provided in the cover plate 13. The deepest positions of the curved portions 11 in a direction perpendicular to the substrate deepen in a stepwise manner depending on the distance to each of the curved portions from the corresponding opening 14 in the cover plate 13. As illustrated in 25A, no curved portions are provided at positions communicating with the pressure chamber 10 from the introduction ports 8 located immediately above the corresponding opening 14, and the shallower curved portions 11a are provided, as in FIG. 19B, at positions other than the above-mentioned positions connecting to the pressure chamber 10 from the introduction ports 8 adjacent thereto. Further, the deeper curved portions 11b are provided, as in FIG. 19C, at positions connecting to the chamber 10 from the introduction ports 8 farther away from the corresponding opening 14. Since the introduction ports located at the positions far from the corresponding opening portion 14 can have low refilling performance, the curved portions at the positions far from the corresponding opening 14 are made deep, which makes it possible to improve refill performance of the introduction ports at the position far from the corresponding opening 14.

As illustrated in FIG. 25B, the shape of the curved portion can be formed as a shallower curved portion 11 by making the position of the corner portion 12 shallow illustrated in FIG. 2C. A deeper curved portion 11 can be formed by making the position of the corner portion 12 deep illustrated in FIG. 2D.

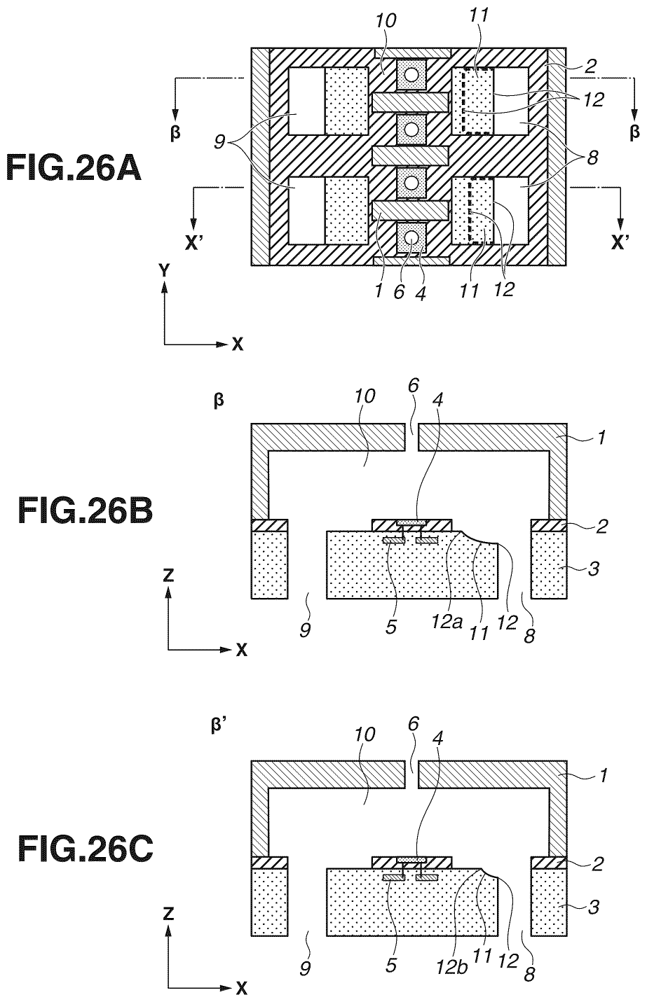

FIG. 26A is a plan view, FIG. 26B is a cross-sectional view at a β-β position in FIG. 26A, and FIG. 26C is a cross-sectional view at an X′-X′ position in FIG. 26A. In FIGS. 26A to 26C, a plurality of corner portions 12 is provided along a plurality of pressure chambers 10. A plurality of corner positions 12, which are a first corner portion 12a formed nearer the energy generation element 4 as in FIG. 26B and a second corner portion 12b formed farther from the energy generation element 4 as in FIG. 26C, is different from each other in distance from the energy generation elements 4. As illustrated in FIGS. 26A to 26C, the corner portions can be different in distance from the energy generation elements 4.

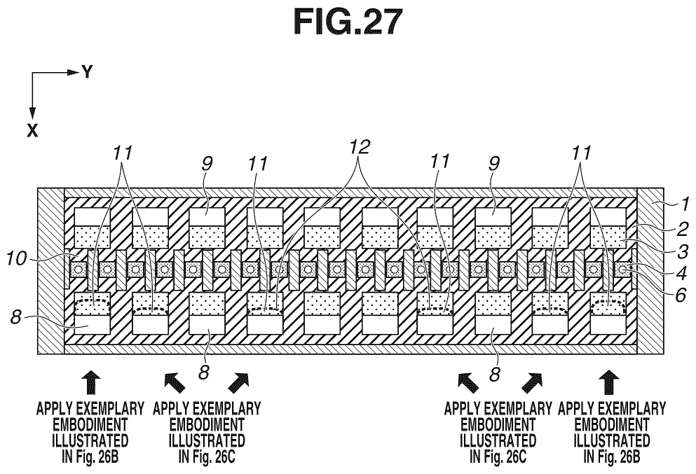

In FIG. 27, on the premise of the configuration in which the cover plate 13 and the openings 14 are provided as in FIG. 25C, no curved portions are provided at positions connecting to the pressure chamber 10 from the introduction ports 8 located immediately above the openings 14, and the curved portions 11 are formed in portions communicating with the pressure chamber 10 from the introduction ports 8 adjacent thereto. The curved portions 11 in the configuration illustrated in FIG. 26C, for example, are formed in portions connecting to the pressure chamber 10 from the introduction ports 8 farther from the corresponding opening portion 14.

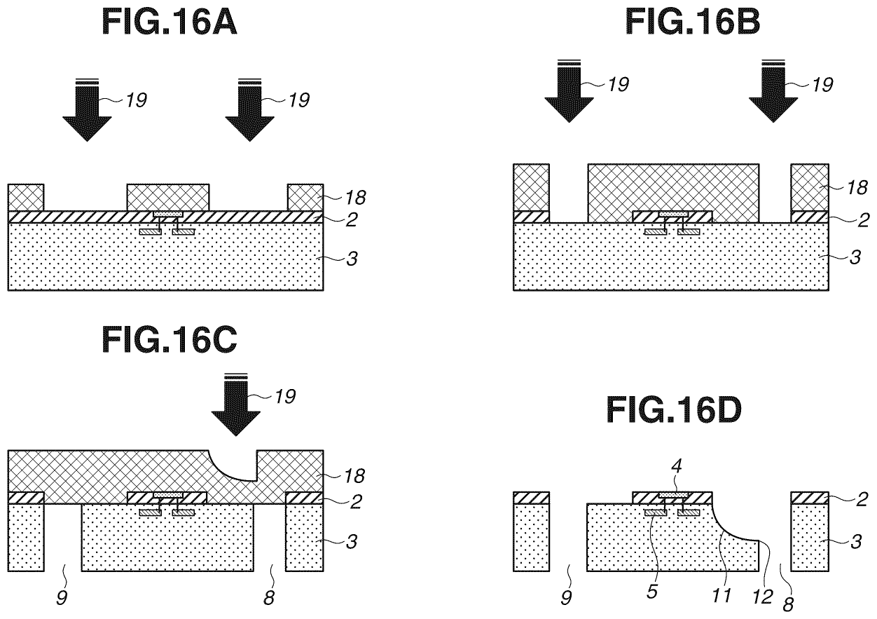

A first manufacturing method will be described. FIGS. 16A to 16D each illustrate a state where the liquid ejection head according to the first exemplary embodiment is formed using the first manufacturing method. As illustrated in FIG. 16A, the substrate 3 on which the energy generation elements 4, a wiring layer 5, and the insulating layer 2 are previously provided is prepared. A desired pattern is formed on the substrate 3 with an etching-resistant resist 18, and an etchant 19 is applied in dry etching, to form engraved portions in the insulating layer 2. As illustrated in FIG. 16B, a desired pattern is further formed with the etching-resistant resist 18, the etchant 19 is applied in dry etching, to form through ports serving as the introduction port 8 and the collection port 9. As illustrated in FIG. 16C, a pattern of the etching-resistant resist 18 is formed at the position corresponding to the curved portion with a gradation mask. The etchant 19 is then applied in dry etching. As a result, the curved portion 11 and the corner portion 12 as illustrated in FIG. 16D are formed in desired shapes.

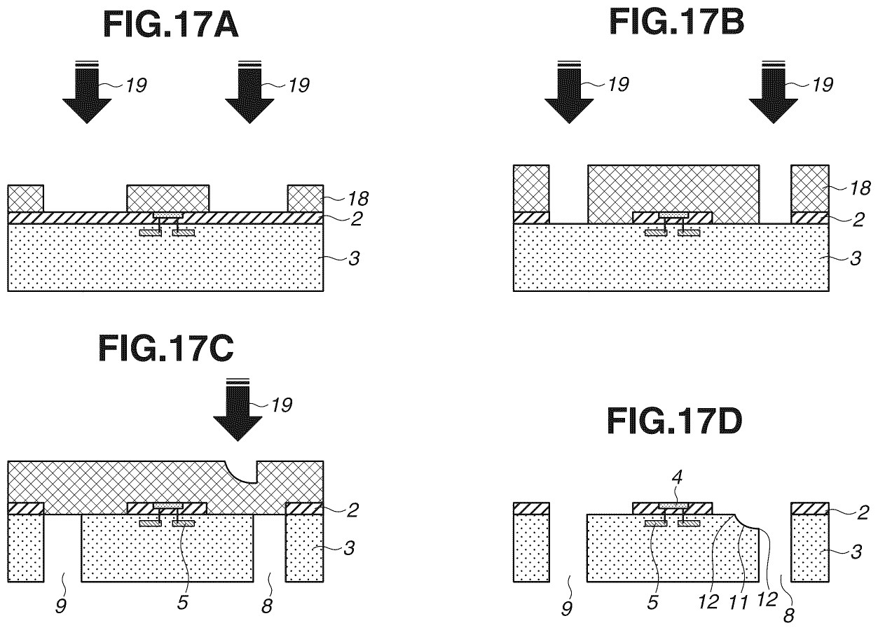

A second manufacturing method will be described. FIGS. 17A to 17D illustrate a state where the liquid ejection head according to the fourth exemplary embodiment is formed using the second manufacturing method. As illustrated in FIG. 17A, the substrate 3 on which the energy generation elements 4, the wiring layer 5, and the insulating layer 2 are previously provided is prepared. A desired pattern is formed on the substrate 3 with the etching-resistant resist 18, and the etchant 19 is applied in dry etching, to form engraved portions in the insulating layer 2. As illustrated in FIG. 17B, a desired pattern is further formed with the etching-resistant resist 18, and the etchant 19 is applied in dry etching, to form through ports serving as the introduction port 8 and the collection port 9. As illustrated in FIG. 17C, a pattern of the etching-resistant resist 18 is formed at the position corresponding to the curved portion with a gradation mask, for example. The etchant 19 is then applied in dry etching. As a result, the curved portion 11 and corner portion 12 as illustrated in FIG. 17D are formed in desired shapes.

A third manufacturing method will be described. FIGS. 18A to 18D illustrate a state where the liquid ejection head according to the fourth exemplary embodiment is formed using the third manufacturing method. As illustrated in FIG. 18A, the substrate 3 on which the energy generation elements 4, the wiring layer 5, and the insulating layer 2 are previously provided is prepared. A desired pattern is formed on the substrate 3 with the etching-resistant resist 18, and the etchant 19 is applied in dry etching, to form engraved portions in the insulating layer 2. As illustrated in FIG. 18B, a desired pattern is further formed with the etching-resistant resist 18, and the etchant 19 is applied in dry etching, to form through ports serving as the introduction port 8 and the collection port 9. As illustrated in FIG. 18C, etching is further performed to produce an action 20 of the etchant with a loading effect, causing the substrate 3 to be further etched. As a result, the curved portion 11 and the corner portion 12 as illustrated in FIG. 18D are formed in desired shapes.

An example will be described. First, the substrate 3 formed by providing the energy generation elements 4 on a silicon substrate was prepared. Resist patterning and etching in desired manners were repeatedly performed on the substrate 3 to form the introduction port 8 and the collection port 9.

Further, patterning and etching for forming the curved portion 11 were performed to form the curved portion 11 having a maximum depth of 10 μm and the corner portion 12. The flow path members 1 were then formed on the substrate 3, and patterning of the flow path members 1 and other processes were performed, forming the liquid ejection head in the desired shape.

According to the exemplary embodiments, a liquid ejection head can be provided that can reduce the inflow of air bubbles into the pressure chamber together with further improved refill performance.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Applications No. 2023-174943, filed Oct. 10, 2023, and No. 2024-081643, filed May 20, 2024, which are hereby incorporated by reference herein in their entirety.

What is claimed is:

1. A liquid ejection head, comprising:
an ejection port configured to eject liquid;
a pressure generation element configured to generate pressure for ejecting the liquid from the ejection port;
a pressure chamber on which the pressure by the pressure generation element acts; and
a substrate where a supply port for supplying the liquid to the pressure chamber is formed,
wherein a curved portion and a corner portion are provided at an end of a surface of the substrate on a pressure chamber side.

2. The liquid ejection head according to claim 1, wherein the curved portion and the corner portion are provided upstream of the pressure chamber in a flowing direction of the liquid flowing over the substrate.

3. The liquid ejection head according to claim 1,
wherein in the substrate, a collection port for collecting the liquid not ejected from the ejection port is formed, and
wherein the curved portion and the corner portion are provided downstream of the pressure chamber in a flowing direction of the liquid flowing over the substrate.

4. The liquid ejection head according to claim 1,
wherein in the substrate, a collection port for collecting the liquid not ejected from the ejection port is formed, and
wherein the curved portion and the corner portion are provided both upstream and downstream of the pressure chamber in a flowing direction of the liquid flowing over the substrate.

5. The liquid ejection head according to claim 1,
wherein in the substrate, a plurality of the curved portions and a plurality of the corner portions are formed along a plurality of the pressure chambers, and
wherein a first curved portion and a second curved portion among the plurality of curved portions have different deepest positions in a direction perpendicular to the substrate.

6. The liquid ejection head according to claim 1,
wherein in the substrate, a plurality of the curved portions and a plurality of the corner portions are formed along a plurality of the pressure chambers, and
wherein a first corner portion and a second corner portion among the plurality of corner portions are at different positions in a direction perpendicular to the substrate.

7. The liquid ejection head according to claim 1,
wherein in the substrate, a plurality of the curved portions is formed along a plurality of the pressure chambers to form a curved portion line, and
wherein, in the curved portion line, the curved portions at end parts and the curved portions at parts other than the end parts have different deepest positions in a direction perpendicular to the substrate.

8. The liquid ejection head according to claim 1,
wherein in the substrate, a plurality of the curved portions is formed along a plurality of the pressure chambers to form a curved portion line, and
wherein, in the curved portion line, the curved portions at end parts have a deeper position than at parts other than the end parts in a direction perpendicular to the substrate.

9. The liquid ejection head according to claim 1,
wherein in the substrate, a plurality of the corner portions is formed along a plurality of the pressure chambers to form a corner portion line, and
wherein, in the corner portion line, the corner portions at end parts and the corner portions at parts other than the end parts are at different positions in a direction perpendicular to the substrate.

10. The liquid ejection head according to claim 1,
wherein in the substrate, a plurality of the corner portions is formed along a plurality of the pressure chambers to form a corner portion line, and
wherein, in the corner portion line, the corner portions at end parts are at deeper positions than at parts other than the end parts in a direction perpendicular to the substrate.

11. The liquid ejection head according to claim 1,
wherein a cover plate is formed at a surface of the substrate opposite to the surface of the substrate on the pressure chamber side,
wherein in the substrate, a plurality of the curved portions is formed along a plurality of the pressure chambers to form a curved portion line, and
wherein, in the curved portion line, the curved portions have deepest positions in a direction perpendicular to the substrate, the deepest positions deepening in a stepwise manner depending on a distance to each of the curved portions from an opening in the cover plate.

12. The liquid ejection head according to claim 11, wherein, in the curved portion line, the curved portions farthest from the opening in the cover plate have a deeper position than the other curved portions in the direction perpendicular to the substrate.

13. The liquid ejection head according to claim 1,
wherein a cover plate is formed at a surface of the substrate opposite to the surface of the substrate on the pressure chamber side,
wherein in the substrate, a plurality of the corner portions is formed along a plurality of the pressure chambers to form a corner portion line, and
wherein, in the corner portion line, the corner portions are at positions deeper in a stepwise manner in a direction perpendicular to the substrate depending on a distance from an opening of the cover plate.

14. The liquid ejection head according to claim 13, wherein, in the corner portion line, the corner portions farthest from the opening of the cover plate are at deeper positions than the other corner portions in the direction perpendicular to the substrate.

15. The liquid ejection head according to claim 1,
wherein in the substrate, a plurality of the corner portions is formed along a plurality of the pressure chambers, and
wherein a first corner portion and a second corner portion among the plurality of corner portions are different in distance from the pressure generation element.

16. The liquid ejection head according to claim 1,
wherein in the substrate, a plurality of the corner portions is formed along a plurality of the pressure chambers to form a corner portion line, and
wherein, the corner portions at end parts and the corner portions at parts other than the end parts are different in distance from the pressure generation element.

17. The liquid ejection head according to claim 1,
wherein in a plurality of the substrate, a plurality of the corner portions is formed along a plurality of the pressure chambers to form a corner portion line, and
wherein, the corner portions at end parts are at deeper positions in distance from the pressure generation element than at parts other than the end parts.

18. The liquid ejection head according to claim 1,
wherein a cover plate is formed at a surface of the substrate opposite to the surface of the substrate on the pressure chamber side,
wherein in the substrate, a plurality of the corner portions is formed along a plurality of the pressure chambers to form a corner portion line, and
wherein, in the corner portion line, the corner portions are nearer to the pressure generation element in a stepwise manner depending on a distance from an opening of the cover plate.

19. The liquid ejection head according to claim 18, wherein, in the corner portion line, the corner portion(s) farthest from the opening of the cover plate is at a position nearest to the pressure generation element.
